(19) United States
(12) Patent Application Publication
(10) Pub. No.: US 2012/0185367 A1
(43) Pub. Date: Jul. 19, 2012

(54) METHOD OF PROVIDING AN ONLINE SECURED ASSET SYSTEM

(76) Inventors: Joshua D. Abramson, San Francisco, CA (US); Kenneth W. Vilkin, Brush Prairie, WA (US); Scott J. Warner, Venice, CA (US)

(21) Appl. No.: 13/341,492

(22) Filed: Dec. 30, 2011

Related U.S. Application Data
(62) Division of application No. 11/768,086, filed on Jun. 25, 2007, now abandoned.

(51) Int. Cl. G06Q 10/08

(52) U.S. Cl. 705/28

(57) ABSTRACT

A method of providing physical escrow of assets includes receiving a request for escrow of an asset from a securing party computer, creating a record of the asset in the vault computer, receiving the asset at a vault storage, receiving a verification of the asset and updating the record with the verification, providing the verification of the asset to the securing party, receiving a notification of a completed transaction at the vault computer, and updating the record to reflect a new owner of the asset.

This application is a divisional of U.S. patent application Ser. No. 11/768,086 filed Jun. 25, 2007, which is a continuation of, and claims priority to, U.S. Provisional Patent Application No. 60/805,718, filed Jun. 23, 2006, and U.S. Provisional Patent Application No. 60/828,886, filed Oct. 10, 2006.

### BACKGROUND

Sites such as eBay® and U-Bid® offer users the ability to sell their items in an online, ‘auction’ format, where the buyers bid for items. The sites offer flexibility for the sellers to set reserve prices, set instant purchase prices, etc. However, the sellers may suffer at the whim of the buyers' behavior on pricing, and the possibility of getting cheated is higher because there is little centralized control, except for other users' ratings and some minimal enforcement by the site administrators. Further, users may not sell their items do to lack of interest or misperceptions of items' worth. There is no appraisal mechanism to provide information on an item's worth, which can hurt both sellers and buyers.

Further, these on line sites are directed solely to sales. Users that have collectibles they could otherwise use to secure loans may have to resort to pawnshops. Pawnshops are the main mass-market option for secured loans on collectibles. There are over 14,000 pawnshops in the United States, and the top five chains alone account for nearly $2 billion in loans annually.

Pawnshops also have several issues that cause some users to avoid them. Interest rates can reach 300%. The loan amounts are generally low compared to the value of the assets used to secure them, usually 30% or less of fair market value. The loans are short-term, three months or less, and when pawnshops do buy they pay only 10-15% of market value. Pawnshops have also gained a negative stigma that drives users away.

### BRIEF DESCRIPTION OF THE DRAWINGS

FIG. 1 shows an on-line asset securing system.

FIG. 2 shows a flow chart of a method of providing physical escrow.

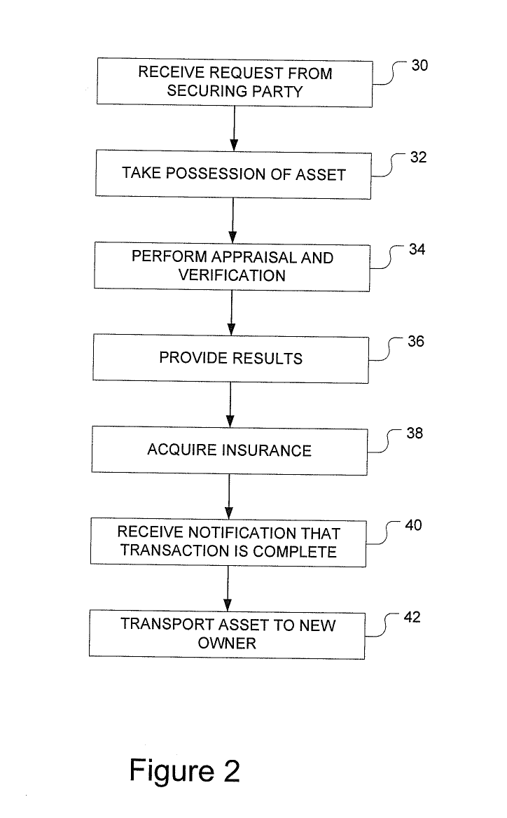

FIG. 3 shows a flow chart of a method of operating a secure on-line asset system.

### DETAILED DESCRIPTION OF THE EMBODIMENTS

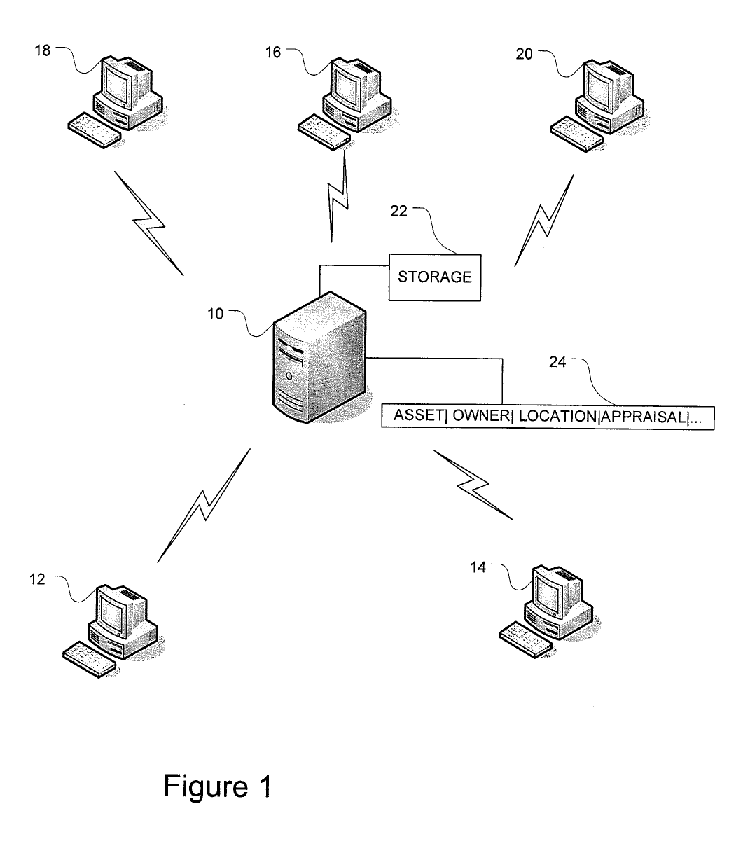

FIG. 1 shows an embodiment of an online system for secured asset transactions. References made here to computers or computer systems may include any combination of processor that can execute instruction and a port or other means of communication, including such examples as a cell phone, a personal computer, a server, a server farm, and a distributed computing system in which the processor or processors, memory and instructions are distributed among several device housings, and even across several communications links. The vault computer 10, for example, may be several computers linked together and represented by one communications interface that is viewed by other computers across the communications link or links. Typically, while each computer here is shown as having a separate link to the vault computer 10, the computers may be members of a network, such as the Internet, or even a virtual private network (VPN), subnet, etc. Similarly, the storage 22, may be a building or other secure facility remote from the vault computer 10, it may also include the premises in which the vault computer is located.

The other portions of the secured asset system may include an owner computer 12, verifier computer 16, a transport computer 18, an insurance computer 20, a database or other electronic means of storing information for access that contains a record such as 24 that records information about a particular asset. The system may also include a computer or other device 14 that belongs to an interested party. An interested party may include an individual, group of individuals or institution, such as a bank or trading house, that has an interest in acquiring, or providing credit secured by, the asset.

The vault system may provide several areas of service to owners and buyers/lenders. The assets are stored in a secured facility, and bids on those assets may be managed through the vault system. The assets receive independent, third party verifications, either standard or ‘premium’ valuation for the assets, providing owners and bidders information as to the worth of the asset. The vault system may also provide an online marketplace for owners. The online marketplace provides access to multiple channels for sale and acquisitions. When something is purchased, the vault system may provide order fulfillment by shipping or transporting the asset to the purchaser. The vault system may provide transaction insurance, confirmation of authenticity and provenance.

In an embodiment, the vault system may act as a physical escrow agent to allow owners to offer their assets for sale through already-existing online marketplaces such as eBay. In this embodiment, the owner manages the sale transaction from offer for sale to payment and release.

Either prior to offering an asset for sale or after locating a potential buyer, the owner or buyer contacts the vault through the vault computer 10 using the owner computer 12, which may also be a buyer's computer at 30. Buyers may want the vault system to confirm the authenticity and provenance of the asset prior to agreeing to a particular purchase price. The party contacting the vault will be referred to more generally as the securing party.

The vault arranges to take possession of the asset from the owner and transports it securely to the vault storage 22 at 32, where the vault system provides physical escrow of the item until the transaction is successfully completed. The vault will track the asset on the vault computer 10 via a record 24. The record may be available to the securing party, as well as to any other interested party to the transaction. Generally the vault system will interact with leading providers of both transportation and storage, to ensure comfort and peace of mind as to the security and preservation of the asset.

Similarly, the vault system will provide independent, third-party verifications, which may include appraisals, of the assets in physical escrow at 34. Upon verifying the authenticity and provenance, or chain of title, of the asset and acquiring the insurance, the vault system will contact the securing party of the results at 36, generally using the vault computer either by a message or by updating a record in an online marketplace listing. The vault system will also acquire both insurance against asset loss and transaction insurance at 40.

If the asset is authentic and has satisfactory provenance, the vault system may provide a vault ‘seal of approval’ to demonstrate that the asset is authentic. This may be separate from any appraisal value given from the vault.

The securing party can then either provide information as to the vault's seal of approval, or, if the securing party is the buyer, have the knowledge that the buyer's satisfaction is guaranteed. For example, the owner that is selling the asset on eBay® may include a graphic representing that the vault system has approved the asset, or may even provide a link to a vault record of the item.

Once the transaction is complete, the securing party contacts the vault computer to inform the vault system that the transaction was successful at 40. The buyer may then elect to have the asset transferred to the buyer through the vault system, or may even decide to have the vault retain possession of the asset until a later date. If the asset is to be transferred, the vault system arranges for secure and trusted transportation of the asset to the buyer at 42. The vault computer will update the record 24 of the status of the asset throughout the process, and will communicate the results of the various stages to other parties as needed.

In this manner, the vault provides physical escrow of assets for high-ticket transactions in electronic marketplaces in a highly secure, trusted manner. This allows seller's to receive verification of the particulars of their assets, and then include those results in their offers for sale, if they so choose. Verification may include appraisals as the market value of an asset, authentication of the asset, confirmation or analysis of its provenance and chain of title, etc.

This verification may allow the asset to be sold more quickly as the concerns of most buyers will be alleviated by the ‘seal of approval.’ It also allows buyers to confirm the particulars of an asset prior to purchase. Buyer satisfaction is also guaranteed with transaction insurance, removal or mitigating the typical risks of online transactions.

In an alternative embodiment, the vault system may act as a both the escrow agent and the online marketplace. The system and its operation may be best understood in the context of an example. This example is provided for ease of discussion and understanding and is in no way intended to limit the scope of the claims, nor should any such limitation be inferred.

In this embodiment, the vault computer provides a forum for owners of assets desiring to sell or to be extended credit based upon the value of the asset to present those assets to a community of interested parties. This forum may be a web site or other group or social mechanism on a network. The owner uses his or her computer system to contact the vault computer to proffer the asset for sale, as is currently done on sites such as eBay®. However, the owner may also be proffering the asset as a means to secure credit.

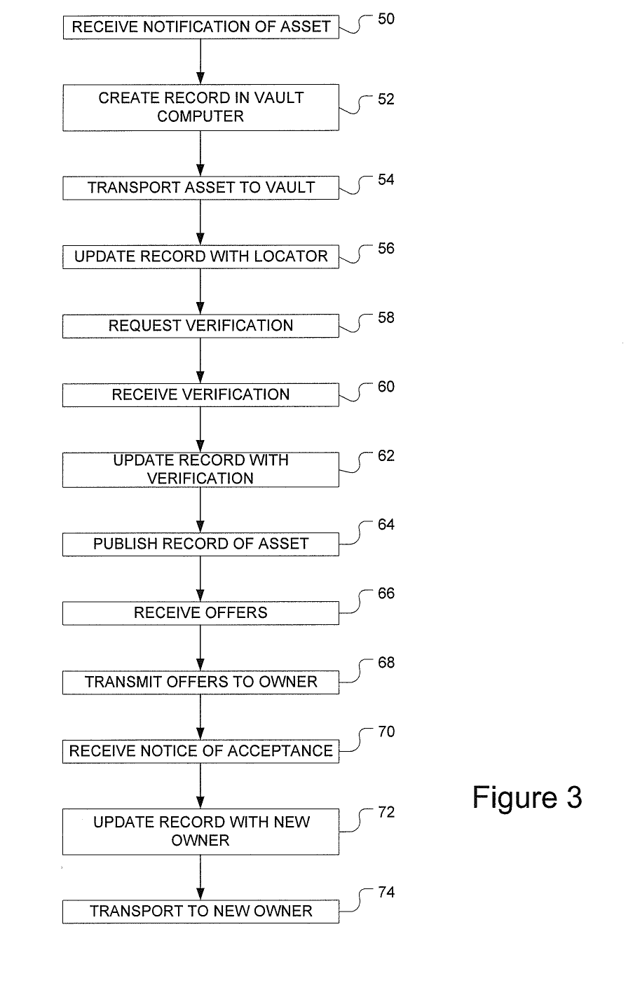

A flow chart of one embodiment of such a transaction is shown in FIG. 3. The following discussion will move back and forth between these figures, and as such, the reference numerals are unique for each entity or process. The owner's initial contact through the owner computer 12 to the vault computer 10 to proffer the asset occurs at 50. At 52, the vault computer creates a record, such as 24, to track the asset.

The next part of the process may be to transport the asset to the storage 22 of the vault. This may involve the vault providing a third-party, highly secure and proven, transportation provided to transport the asset. The vault computer 10 may contact a transporter computer 18 with the parameters of the transaction to allow the transportation provider to work with owner to transport the asset. Further, the transport computer 18 may actually be a collection of transporter computers that all receive the request for transportation and they bid on the transportation contract for the asset, with the vault computer receiving the bids and the vault administrator making the selection of the transporter. The record 24 may be updated at 56 with transportation information such as the transportation provider, a pick up date, delivery date, etc. As will be discussed further in the process, the order of some of these processes, as well as their employment at all in the overall process, is optional.

Once the asset is transported to the vault storage 22, the location of the asset is noted in the record. This may be a location within one storage vault, a designator of which of a plurality of vaults, as well as the location within a particular vault, etc. It is envisioned that there may be several vault storages located in convenient locations.

Of particular note in the secure asset system described here, the system provides a verification of the asset's worth, generally by third party experts in whichever area of expertise the asset falls. If the asset is a painting and the verification desired is an appraisal, the verifier would be an expert appraiser in art or paintings within the art world. The vault computer requests a verification from the verifier computer 16 at 58.

It must be noted that the asset may be verified at the asset's location when initially proffered, or it may occur at the vault storage 22. As mentioned before, the order of these processes, if included at all, is optional. In the first instance, the appraiser computer 16 would be reached upon a communications link such as the Internet or VPN, and the verifier would provide the verification results at 60 through the verifier computer to the vault computer 10.

In the instance where the verification occurs at the vault storage 22, the verifier computer and the vault computer may be the same computer. Alternatively, the verifier computer may be the workstation of an appraiser that works in the same building or locale as the vault storage. The request for verification may just be an entry into a work flow system that causes the record of the asset to be highlighted or otherwise held until the verification is complete at 60, and the record updated with the results of the verification at 62. The results of the verification may include the appraised value, the condition, such as Mint, Excellent, Good, Fair, Poor, and/or a confirmation of the chain of title or provenance of the asset.

Upon receipt of the verification, and possibly confirmation of the verification of the value by the owner, the asset record is published to the community of interested parties at 64. The publication may include the nature of the transaction, such as sale or loan, and terms sought by the owner, such as a minimum price, interest rate or term of the loan, as well as any restrictions on the asset's sale or use as a security. This publication will more than likely be accomplished by the vault computer 10, by posting on a web site or other similar mechanism.

The community of interested parties, such as individuals, trading houses, banks, etc., would then be free to bid on the transaction, either for purchase or to extend credit for a loan or line of credit based upon the appraisal value of the asset. These offers may be posted on the web site, or sent directly to the owner computer 12 from a computer of an interested party such as 14. If the offers are sent directly to the owner computer 12, some mechanism would be helpful to allow the vault computer to be aware of the offers available at 66. In an alternative embodiment, the bidders may bid offline by a conference telephone call, in the interest of speed and fairness, as the speed of the various communications links may vary.

If the offers are sent to the vault computer 10, the offers are then transmitted to the owner computer 12 at 68. The owner can then review the offers at his/her leisure, unless the interested parties have put a time limit on their offers. Once the owner selects an offer for a sale or loan, the owner computer notifies the vault computer at 70. The purchaser or lien holder may be entered into the record of the asset as the ‘new owner’ at 72. If the purchase actually wishes to take possession of the asset, the vault computer may notify the vault administrator of a need to transport the asset to the new owner at 74. The new owner may decide to leave the asset in the vault, either until such time as he/she decides to sell, if the transaction is a sale, or until the loan or line of credit is paid off and closed, if the transaction is a loan.

In this manner, a community of lenders/purchasers is allowed to bid on loans or sales of assets, based upon an independent third party appraisal, rather than on the whim of an online bidding action. Also, if one of the owner's goals is to get the asset out of their possession, where the owner may or may not be able to sell on a bidding site, the owner can move the asset to a secure storage facility until such opportunity arises. If one of the owner's needs is to get money for the asset, the owner has the ability to receive a loan based upon the value of the asset, and have immediate access to cash, the owner would not be prevented from that access because of an inability to sell the asset on a bidding site.

Many variations, modifications and embellishments to this system are possible. For example, the vault computer 10 may contact an insurer computer 20 with a request for insurance coverage of the asset while in storage and/or while in transit. The vault may also be able to provide transaction insurance if something goes awry during the transaction such as theft, or forgery. Any of the services provided may be provided through a competitive bidding process, where the providers contacted by the vault with requests compete for the contract for that particular service for the asset, such as verification, insurance and transportation.

As mentioned previously, the order and existence of any of the processes is optional, for the most part. The owner proffers the asset for sale or loan, there is a verification done and information about the asset and its verification information are published to the community of interested parties. Transportation, insurance, location of storage, etc., are optional.

Other modifications may include all of the services being provided internal to the vault system. However, it is assumed that owners would be more comfortable with the different aspects of the system being provided by established, experienced, and trusted names in those areas.

Thus, although there has been described to this point a particular embodiment for a method and apparatus for one-way wireless binding between devices, it is not intended that such specific references be considered as limitations upon the scope of this invention except in-so-far as set forth in the following claims.

What is claimed is:

1. A method of providing physical escrow of assets, comprising:
receiving, at a vault computer, a request for escrow of an asset from a securing party computer;
creating a record of the asset in the vault computer;
receiving the asset at a vault storage;
receiving a verification of the asset and updating the record with the verification;
providing the verification of the asset to the securing party;
receiving a notification of a completed transaction at the vault computer; and
updating the record to reflect a new owner of the asset.

2. The method of claim 1, the method further comprising sending, from the vault computer, a request for transport to a transporter computer.

3. The method of claim 1, the method further comprising requesting, from the vault computer, a request for verification to a verifier computer.

4. The method of claim 1, wherein providing the verification of the asset further comprises sending a message from the vault computer to the securing party computer.
